(19) United States
(12) Patent Application Publication
(10) Pub. No.: US 2016/0239121 A1
(43) Pub. Date: Aug. 18, 2016

(54) CURVED CAPACITIVE TOUCH PANEL AND METHOD OF MANUFACTURING THE SAME

(71) Applicant: DEXERIALS CORPORATION, Tokyo (JP)

(72) Inventors: Yukio MURAKAMI, Yokohama-shi, Kanagawa (JP); Yoshiaki IMAMURA, Miyagi-gun, Miyagi (JP); Hirokazu ODAGIRI, Sendai-shi, Miyagi (JP)

(73) Assignee: Dexerials Corporation, Shinagawa-ku, Tokyo (JP)

(21) Appl. No.: 15/022,267

(22) PCT Filed: Sep. 16, 2014
(86) PCT No.: PCT/JP2014/004756

§ 371 Date: Mar. 16, 2016

(30) Foreign Application Priority Data
Sep. 27, 2013 (JP) 2013-200857

(51) Int. Cl. G06F 3/044; G06F 3/041

(52) U.S. Cl. CPC G06F 3/044; G06F 3/0416; G06F 2203/04103

(57) ABSTRACT

Provided is a curved capacitive touch panel including a curved capacitive touch panel substrate including: a transparent panel substrate; a decorative print layer disposed on a peripheral section of a rear surface of the transparent panel substrate; a step prevention layer flatly covering across a rear surface of the decorative print layer and inward of the decorative print layer on the rear surface of the transparent panel substrate; a sensor section including a transparent electrode layer that is disposed on a rear surface of the step prevention layer; and a transparent protective film covering the entire surface of the sensor section with the exception of a thermal compression bonding region substrate. The touch panel also includes an external connection substrate bonded by thermal compression to the thermal compression bonding region.

### CROSS-REFERENCE TO RELATED APPLICATION

This application claims the priority of Japanese Patent Application No. 2013-200857 (filed on Sep. 27, 2013), the entire disclosure of which is incorporated herein by reference.

### TECHNICAL FIELD

The present disclosure relates to a curved capacitive touch panel including a top plate in which a transparent resin base material is used.

### BACKGROUND

There is currently widespread use of smart phones, tablet PCs, and so forth that can be easily operated using a touch panel. Provision of thinner, lighter, and cheaper touch panels is a pressing issue.

A touch panel may adopt any of various detection methods including, for example, a resistive film method in which an instruction position is identified through two resistive films that are superimposed on one another and a surface acoustic wave method in which instruction position detection is performed through generation of an ultrasonic wave or a surface acoustic wave on the panel surface. A touch panel used in a smart phone or a tablet PC such as described above is required to handle complicated and highly flexible operations such as tapping or dragging of a finger on the panel, a pinching out movement of moving two fingers further apart on the screen to enlarge an image, and a pinching in operation of moving two fingers closer together. Consequently, at present, the most common touch panels are capacitive touch panels that have an xy matrix formed by a transparent electrode and that can simultaneously detect a plurality of instruction positions.

Various investigations have been conducted into provision of thinner, lighter, and cheaper touch panels, one example of which is that a top plate made from a resinous material has been tested as a replacement for a glass top plate that covers the surface of, and thereby protects, a capacitive sheet in which a transparent electrode is formed (for example, refer to PTL 1).

When a resinous top plate is used in a capacitive touch panel, a resin material having a high heat resistance, such as a polycarbonate (PC) resin, is commonly used due to the high temperature environment in manufacturing of the touch panel or manufacturing of a liquid-crystal panel in which the touch panel is mounted. The surface of a touch panel is susceptible to scratching because it is exposed to the surrounding environment. The surface of a top plate made from a PC resin may be scratched due to the low hardness of the PC resin, which may be problematic in terms of design or visibility. Consequently, the top plate is provided with a multi-layer structure in which the surface is made from a hard resin having a high hardness. For example, a multi-layer transparent resin base material made from a PC resin and an acrylic resin (poly(methyl methacrylate), PMMA) has been developed using a two-layer extrusion technique.

Furthermore, 2.5D and 3D specification touch panel products have conventionally been developed by pasting glass or a film to thermally molded product of a plastic material subjected to decorative printing or a housing manufactured with a curved shape by an in-mold process in which a film is thermally molded and provided with filling rigidity (for example, refer to PTL 2 and 3).

### CITATION LIST

### Patent Literature

PTL 1: JP2000-207983 A

PTL 2: JP2012-043165 A

PTL 3: JP5113960

### SUMMARY

### Technical Problem

When a touch panel is mounted on a smart phone or the like having a curved housing, it has conventionally been necessary to paste the curved housing and the touch panel together. As it has not been possible to paste the touch panel uniformly onto the curved housing by a pasting-type adhesive, pasting of the touch panel onto the curved housing has had to be carried out using a resin in a liquid state.

However, the operation of pasting the touch panel using the liquid-state resin is problematic due to its poor yield. Furthermore, when the touch panel is pasted onto the curved housing using the liquid-state resin, locations may arise where there are different distances between the housing and a sensor of the touch panel, which is problematic as it limits functionality as an electrostatic touch panel.

The present disclosure was conceived in light of conventional problems such as described above and an objective thereof is to provide a thinner and lighter curved capacitive touch panel in which a top plate including a transparent resin base material is integrated with a curved housing such that an operation of pasting the touch panel and the housing together is not required.

Other objectives of the present disclosure and specific advantageous obtained through the present disclosure should become further apparent through the explanation of embodiments that follows.

### Solution to Problem

A curved capacitive touch panel according to the present disclosure includes a curved capacitive touch panel substrate that is formed by thermally molding, into a three-dimensional shape, a capacitive touch panel substrate having a heat resistance temperature that is higher than a temperature of thermal molding and including: a transparent panel substrate including a transparent resin base material; a decorative print layer disposed on a peripheral section of a rear surface of the transparent panel substrate; a step prevention layer made from a transparent resin material and flatly covering across a rear surface of the decorative print layer and inward of the decorative print layer on the rear surface of the transparent panel substrate on which the decorative print layer is disposed; a sensor section including a transparent electrode layer that is disposed on a rear surface of the step prevention layer; and a transparent protective film covering the entirety of a rear surface of the sensor section with the exception of a thermal compression bonding region for an external connection substrate. The curved capacitive touch panel also includes the external connection substrate that is bonded by thermal compression to the thermal compression bonding region of the sensor section.

In the curved capacitive touch panel according to the present disclosure, the transparent panel substrate may be made from one or more transparent resin base materials from among acrylic (PMMA) resins, polycarbonate (PC) resins, cyclo-olefin polymer (COP) resins, and polyethylene terephthalate (PET) resins having a heat resistance temperature that is higher than the temperature of thermal molding of the curved capacitive touch panel substrate. Furthermore, the transparent panel substrate may include the transparent resin base material and a transparent resin layer disposed on one surface of the transparent resin base material and made from a different material to the transparent resin base material.

A method of manufacturing a curved capacitive touch panel according to the present disclosure includes a substrate preparation step of preparing a capacitive touch panel substrate having a heat resistance temperature that is higher than a temperature of thermal molding and including: a transparent panel substrate including a transparent resin base material; a decorative print layer disposed on a peripheral section of a rear surface of the transparent panel substrate; a step prevention layer made from a transparent resin material and flatly covering across a rear surface of the decorative print layer and inward of the decorative print layer on the rear surface of the transparent panel substrate on which the decorative print layer is disposed; a sensor section including a transparent electrode layer that is disposed on a rear surface of the step prevention layer; and a transparent protective film covering the entirety of a rear surface of the sensor section with the exception of a thermal compression bonding region for an external connection substrate. The method also includes a thermal molding step of preparing a curved capacitive touch panel substrate by thermally molding, into a three-dimensional shape, the capacitive touch panel substrate prepared in the substrate preparation step, and a thermal compression bonding step of bonding the external connection substrate, by thermal compression, to the thermal compression bonding region of the sensor section of the curved capacitive touch panel substrate prepared in the thermal molding step.

### Advantageous Effect

The present disclosure can provide a thinner and lighter curved capacitive touch panel in which a top plate including a transparent resin base material is integrated with a curved housing such that an operation of pasting the touch panel and the housing together is not required.

### BRIEF DESCRIPTION OF THE DRAWINGS

In the accompanying drawings:

FIG. 1 is an external perspective view illustrating an example of a curved capacitive touch panel according to the present disclosure;

FIG. 2 is a cross-sectional view along a line AA′ in FIG. 1 illustrating structure of the curved capacitive touch panel;

FIGS. 3A, 3B and 3C schematically illustrate production steps of the curved capacitive touch panel; and

FIG. 4A is a plan view of the capacitive touch panel and FIG. 4B is a cross-sectional view along a line AA′ in FIG. 4A, each illustrating structure of a capacitive touch panel substrate used in the manufacture of the curved capacitive touch panel.

### DETAILED DESCRIPTION

The following explains embodiments of the present disclosure in detail, with reference to the drawings. Of course, the present disclosure is not limited to the following embodiments and various alterations may be made without deviating from the essence of the present disclosure. It should be noted that dimensions of sections of the drawings are illustrated schematically. In particular, dimensions in a thickness direction in cross-sectional views are emphasized in order to clarify structure.

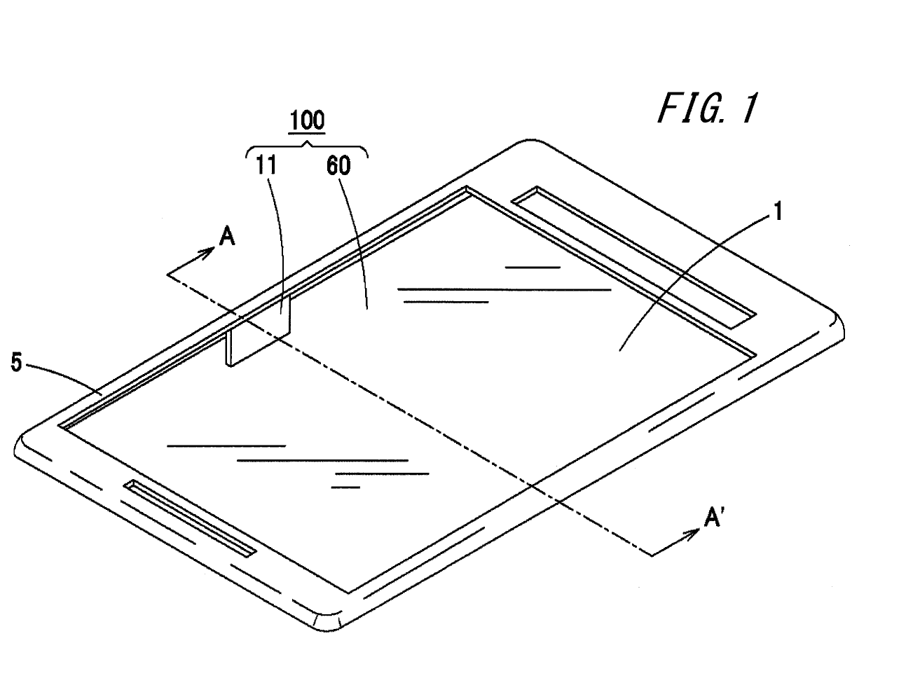

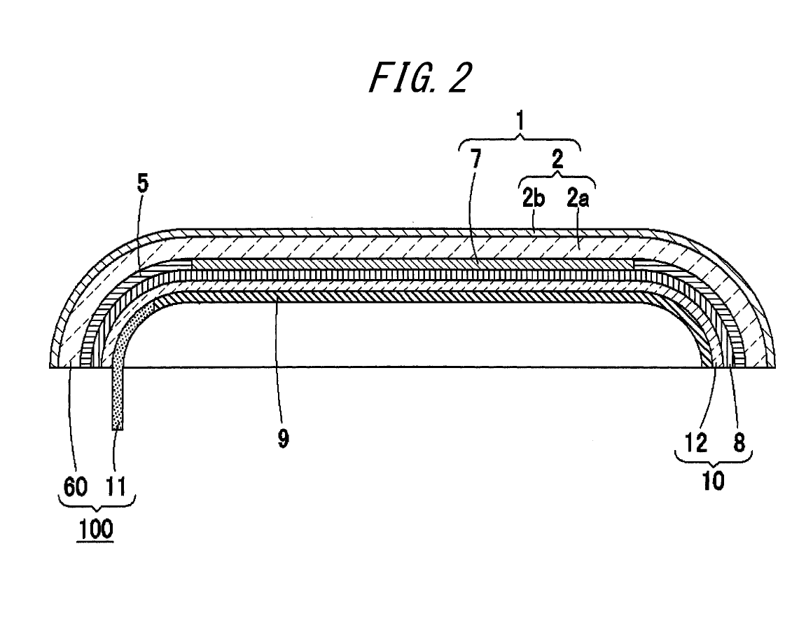

FIG. 1 is an external perspective view and FIG. 2 is a cross-sectional view along a line AA′ in FIG. 1, each illustrating an example of a curved capacitive touch panel 100 according to the present disclosure.

The curved capacitive touch panel 100 includes a curved capacitive touch panel substrate 60 and an external connection flexible printed substrate 11 that is bonded to the curved capacitive touch panel substrate 60 by thermal compression. The curved capacitive touch panel substrate 60 is formed by thermally molding, into a curved shape, a single top plate 1 composed of a transparent resin base material having a sensor section 10 disposed directly on a rear surface side thereof.

As illustrated by the cross-sectional view in FIG. 2, the curved capacitive touch panel substrate 60 includes a transparent panel substrate 2 that includes a transparent resin base material, a decorative print layer 5 that is disposed on a peripheral section of a rear surface of the transparent panel substrate 2, a step prevention layer 7 that is made from a transparent resin material and that flatly covers across a rear surface of the decorative print layer 5 and inward of the decorative print layer 5 on the rear surface of the transparent panel substrate 2 on which the decorative print layer 5 is disposed, a transparent electrode layer 8 disposed on a rear surface of the step prevention layer 7, an insulating layer-equipped jumper wiring layer 12 disposed on a rear surface of the transparent electrode layer 8, and a transparent protective film 9 covering the entirety of a rear surface of the jumper wiring layer 12 with the exception of a thermal compression bonding region for an external connection substrate. The curved capacitive touch panel substrate 60 is thermally molded into a prescribed curved shape.

The external connection flexible printed substrate 11 is bonded by thermal compression to the thermal compression bonding region of the jumper wiring layer 12 in the curved capacitive touch panel substrate 60 that has been thermally molded into the prescribed curved shape.

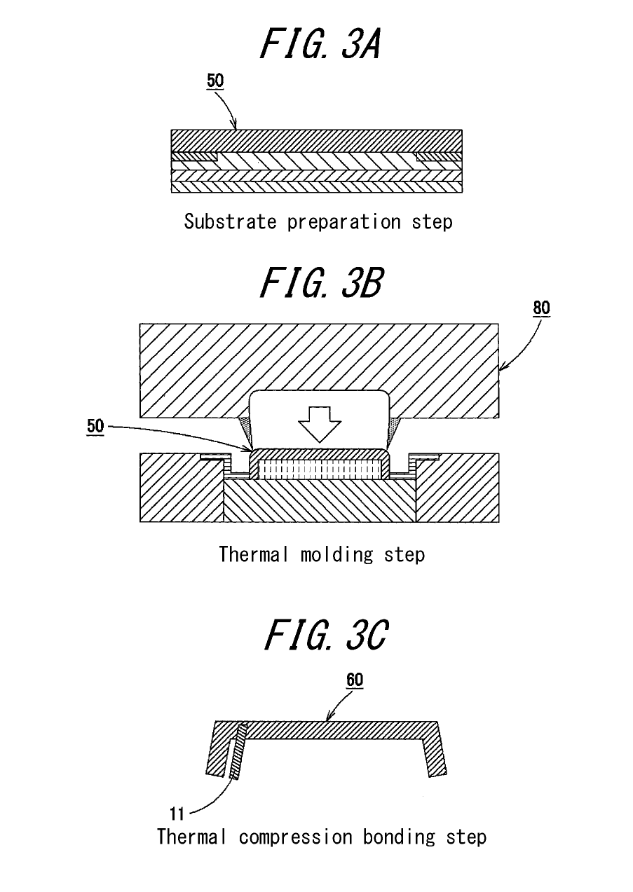

The curved capacitive touch panel 100 having the structure described above can for example be manufactured through manufacturing steps (A), (B), and (C) illustrated in FIG. 3.

An initial substrate preparation step (A) involves preparing a capacitive touch panel substrate 50 that is to be thermally molded in a thermal molding step (B).

Herein, the transparent panel substrate 2 has a thickness of from 0.2 mm to 3 mm and preferably has a thickness of from 0.5 mm to 2 mm in order to satisfactorily function as the top plate 1 used in the curved capacitive touch panel 100. The transparent panel substrate 2 can for example be made from one or more transparent resin base materials from among acrylic (PMMA) resins, polycarbonate (PC) resins, cyclo-olefin polymer (COP) resins, and polyethylene terephthalate (PET) resins having a heat resistance temperature that is higher than a thermal molding temperature of 190° C. Not only the transparent panel substrate 2 of the capacitive touch panel substrate 50, but also the step prevention layer 7, the transparent electrode layer 8, the jumper wiring layer 12, the transparent protective film 9, and so forth are made from materials that are resistant to the thermal molding temperature in the thermal molding step (B).

Furthermore, the transparent panel substrate 2 may include the transparent resin base material and a transparent resin layer that is disposed on one surface of the transparent resin base material and that is made from a different material to the transparent resin base material.

In the subsequently performed thermal molding step (B), the capacitive touch panel substrate 50 prepared through the substrate preparation step (A) is thermally molded into a desired three-dimensional shape by a thermal molding device 80 at a thermal molding temperature of 190° C. to prepare the curved capacitive touch panel substrate 60.

Thereafter, in a thermal compression bonding step (C), the curved capacitive touch panel 100 is completed by bonding the external connection flexible printed substrate 11, by thermal compression, to the thermal compression bonding region of the jumper wiring layer 12 in the curved capacitive touch panel substrate 60 prepared through the thermal molding step (B).

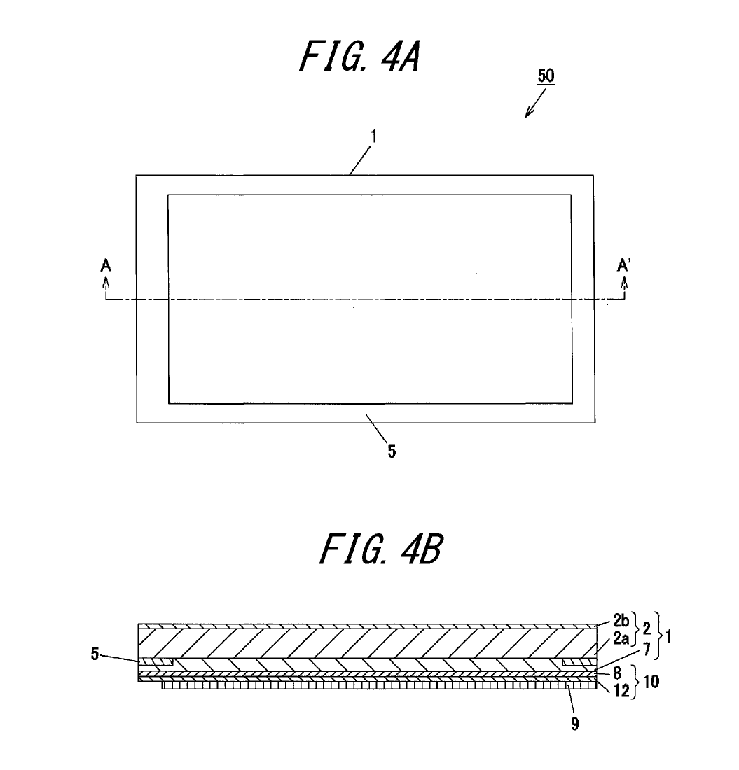

As illustrated by the front view in FIG. 4A and the cross-sectional view in FIG. 4B along the line AA′ in FIG. 4A, the capacitive touch panel substrate 50 prepared in the substrate preparation step (A) includes the top plate 1 as an upper section structure and the sensor section 10 that is disposed on the rear surface side of the top plate 1 and that is composed of the transparent electrode layer 8 and the insulating layer-equipped jumper wiring layer 12.

As illustrated in FIG. 4B, the top plate 1 includes the transparent panel substrate 2, which includes a transparent resin base material 2a containing a resin material having a high heat resistance and a transparent resin layer 2b containing a hard resin material having a high hardness disposed on one surface—specifically, a front surface—of the transparent resin base material 2a, the decorative print layer 5, which is disposed on a peripheral section of the other surface—specifically, a rear surface—of the transparent resin base material 2a, and the step prevention layer 7, which covers across the decorative print layer 5 and the top plate 1 at the rear surface side thereof.

The transparent resin base material 2a is preferably made from a PC resin, which is a resin material having a high heat resistance, and the transparent resin layer 2b is preferably made from a PMMA resin, which is a hard resin material having a high hardness. Scratch resistance of the surface of a touch panel is usually evaluated by pencil hardness (Scratch hardness test, JIS K 5600). A PC resin has a surface hardness of from 2B to F and is susceptible to scratching when used alone as a base material. On the other hand, a PMMA resin has a surface hardness of from H to 2H and is a preferable material for the surface of a touch panel. A touch panel that is resistant to scratching can be realized by forming the transparent resin layer 2b made from a PMMA resin or the like on one surface of the transparent resin base material 2a made from a PC resin or the like such that, in other words, the transparent resin layer 2b is formed at a front surface side of the curved capacitive touch panel 100.

The transparent panel substrate 2 composed of the transparent resin base material 2a and the transparent resin layer 2b disposed on the surface thereof can be formed by a simultaneous melt-molding process using two types of resin materials.

The decorative print layer 5 is provided with an objective of covering a region in which electrodes, wiring, and so forth required for touch panel functionality are present in a peripheral section of a liquid-crystal screen in a smart phone, tablet terminal, or the like such that the aforementioned region is not externally visible as a frame region. The decorative print layer 5 is formed by overlapping coating of a plurality of layers of colored ink by silk screen printing. In order to apply the decorative print layer 5 with a prescribed thickness that ensures that electrodes, wiring, and so forth present in the frame region are not visible, it is necessary to perform a plurality of coatings with a thin thickness per each coated layer to form a printed layer with a multi-layer structure since performing one coating with a thick thickness is likely to result in uneven coating. For example, when coating is performed with an ink of a deep color through which light does not easily pass, it is necessary to form a printed layer through two coatings of the ink, whereas when coating is performed with an ink of a pale color (for example, white) through which light easily passes, it is necessary to perform roughly four overlapping coatings. Thus, a pale color ink layer has a thickness of approximately 32 μm in a situation in which the coating thickness per coating is approximately 8 μm.

The step prevention layer 7 flatly covers across the entirety of the decorative print layer 5 and the rear surface of the transparent resin base material 2a. The step prevention layer 7 is preferably made from a resin material having a linear expansion coefficient that is roughly equal to a linear expansion coefficient of the material from which the transparent resin layer 2b on the front surface side of the transparent resin base material 2a is made. Although no specific limitations are placed on the material of the step prevention layer 7, examples of materials that can be used include transparent acrylic resin coatings and urethane resin coatings that are used as UV curable inks and thermosetting inks. Specific examples that can be used include coatings having urethane (meth)acrylate, epoxy (meth)acrylate, polyester (meth)acrylate, polyester urethane (meth)acryl ate, polyether (meth)acrylate, polycarbonate (meth)acrylate, polycarbonate urethane (meth)acrylate, or the like as a material. Haze, which represents diffuse transmitted light as a proportion of total transmitted light, preferably does not exceed 1% in order that optical characteristics of the touch panel are not affected. By applying a transparent acrylic resin coating, urethane resin coating, or the like having a low viscosity, a step that is created between the decorative print layer 5 and the transparent resin base material 2a can be roughly flattened so as to prevent cutting of wiring by the step when the transparent electrode layer 8 is connected. As explained above, the decorative print layer 5 has a thickness of approximately 32 μm in a situation in which decorative printing is performed using a pale color ink. Therefore, in such a situation, an acrylic coating is for example preferably applied across the decorative print layer 5 and the rear surface of the transparent resin base material 2a with a thickness of approximately 35 μm to form the step prevention layer 7. Besides silk screen printing, the acrylic coating that forms the step prevention layer 7 can also be coated directly using a die coater. The step prevention layer 7 described above can be formed by a commonly known coating technique. Therefore, the step prevention layer 7 can be formed without requirement of specialized equipment and can be formed using the same equipment as used in a printing process for the decorative print layer 5, which enables reduced manufacturing costs.

As described above, the step prevention layer 7 flatly covers across the entire surface of the decorative print layer 5 and the rear surface of the transparent resin base material 2a such that the step created between the decorative print layer 5 and the transparent resin base material 2a is flattened, and thus fulfills a function of preventing cutting of wiring by the step when the transparent electrode layer 8 is connected. In addition, the step prevention layer 7 also functions as a warping preventer that prevents warping, due to ambient temperature, of the transparent panel substrate 2 having the two-layer structure composed of the transparent resin layer 2b and the transparent resin base material 2a that are made from two types of resin materials.

The transparent electrode layer 8 disposed below the step prevention layer 7 is a layer in which a transparent electrode is formed in a transparent film. If an inorganic material of an ITO film is used, cracking occurs readily due to bending of the electrode surface during thermal molding in the thermal molding step (B). Therefore, in consideration of flexibility, a material containing nanowires or nanoparticles of silver, copper, or an alloy thereof is used. In the case of a capacitive touch panel, xy coordinates of a touch position are normally identified using a transparent electrode film having a two-layer structure in which an x axis direction electrode and a y axis direction electrode are formed in two films, but the transparent electrode layer 8 can be provided as a single layer by forming, as a multi-layer structure, a transparent electrode layer 8 formed using Ag nanowires and jumper wiring for identifying xy coordinates of the transparent electrode. Formation of the transparent electrode layer 8 as a single layer enables provision of a thinner and lighter curved capacitive touch panel 100 and can reduce the number of manufacturing steps, which can reduce manufacturing costs. A wiring electrode of the jumper wiring layer 12 becomes a section with a large curvature and is therefore formed using a material such as silver paste that takes into account the change in dimensions upon deformation and also takes into account heat resistance during thermal molding.

The transparent protective film 9 is formed to cover the entirety of the rear surface of the insulating layer-equipped jumper wiring layer 12 with the exception of the thermal compression bonding region for the external connection flexible printed substrate 11 in order to protect the jumper wiring layer 12, and the flexible printed substrate 11 is connected in order to allow connection to an external circuit. The transparent protective film 9 can be made from a commonly known material and can for example be formed through coating with a thermosetting acrylic resin.

The top plate 1 used in the curved capacitive touch panel 100 described above includes the transparent panel substrate 2, which is composed of the transparent resin base material 2a and the transparent resin layer 2b formed on one surface of the transparent resin base material 2a using a different material to the transparent resin base material 2a, the decorative print layer 5, which is disposed on the peripheral section of the rear surface of the transparent panel substrate 2, the step prevention layer 7, which is made from a transparent resin material having a heat resistance temperature that is higher than a thermal compression bonding temperature of the flexible printed substrate 11 and which flatly covers over the rear surface of the decorative print layer 5 and inward of the decorative print layer 5 on the rear surface of the transparent panel substrate 2 on which the decorative print layer 5 is disposed, the transparent electrode layer 8, which is disposed on the rear surface of the step prevention layer 7, the insulating layer-equipped jumper wiring layer 12, which is disposed on the transparent electrode layer 8, and the transparent protective film 9, which is disposed on the jumper wiring layer 12.

### EXAMPLE

Resin top plate base material: PC resin+PMMA resin material (D02U, produced by Mitsubishi Gas Chemical Company), thickness 0.8 mm

Display unit size: 90 mm×55 mm

Decorative print layer: MRX-HF919 black (produced by Teikoku Printing Inks Mfg. Co., Ltd.)

Warping prevention layer: RL-9262 (produced by Sanyu Rec Co., Ltd.)

Transparent electrode layer: Silver nanowire ink

Insulating layer: TPAR-P1510PM (produced by Tokyo Ohka Kogyo Co., Ltd.)

Wiring jumper: AF6100 (produced by Taiyo Ink Mfg. Co., Ltd.)

Transparent resin coating: FR-1TNSD9 (produced by Asahi Chemical Research Laboratory Co., Ltd.)

After preparation with the materials listed above, thermal molding was performed and finally FPC compression bonding was performed.

It was confirmed that there were no problems in terms of functionality.

### REFERENCE SIGNS LIST

1 top plate

2a transparent resin base material

2b transparent resin layer

2 transparent panel substrate

5 decorative print layer

7 step prevention layer

8 transparent electrode layer

9 transparent protective film

10 sensor section

11 flexible printed substrate

12 insulating layer-equipped jumper wiring layer

50 capacitive touch panel substrate

60 curved capacitive touch panel substrate

80 thermal molding device

100 curved capacitive touch panel

1. A curved capacitive touch panel comprising
a curved capacitive touch panel substrate that is formed by thermally molding, into a three-dimensional shape, a capacitive touch panel substrate having a heat resistance temperature that is higher than a temperature of thermal molding and including: a transparent panel substrate including a transparent resin base material; a decorative print layer disposed on a peripheral section of a rear surface of the transparent panel substrate; a step prevention layer made from a transparent resin material and flatly covering across a rear surface of the decorative print layer and inward of the decorative print layer on the rear surface of the transparent panel substrate on which the decorative print layer is disposed; a sensor section including a transparent electrode layer that is disposed on a rear surface of the step prevention layer; and a transparent protective film covering the entirety of a rear surface of the sensor section with the exception of a thermal compression bonding region for an external connection substrate, and
the external connection substrate that is bonded by thermal compression to the thermal compression bonding region of the sensor section.

2. The curved capacitive touch panel of claim 1, wherein
the transparent panel substrate is made from one or more transparent resin base materials from among acrylic resins, polycarbonate resins, cyclo-olefin polymer resins, and polyethylene terephthalate resins having a heat resistance temperature that is higher than the temperature of thermal molding of the curved capacitive touch panel substrate.

3. The curved capacitive touch panel of claim 2, wherein
the transparent panel substrate includes the transparent resin base material and a transparent resin layer disposed on one surface of the transparent resin base material and made from a different material to the transparent resin base material.

4. A method of manufacturing a curved capacitive touch panel, comprising
a substrate preparation step of preparing a capacitive touch panel substrate having a heat resistance temperature that is higher than a temperature of thermal molding and including: a transparent panel substrate including a transparent resin base material; a decorative print layer disposed on a peripheral section of a rear surface of the transparent panel substrate; a step prevention layer made from a transparent resin material and flatly covering across a rear surface of the decorative print layer and inward of the decorative print layer on the rear surface of the transparent panel substrate on which the decorative print layer is disposed; a sensor section including a transparent electrode layer that is disposed on a rear surface of the step prevention layer; and a transparent protective film covering the entirety of a rear surface of the sensor section with the exception of a thermal compression bonding region for an external connection substrate,
a thermal molding step of preparing a curved capacitive touch panel substrate by thermally molding, into a three-dimensional shape, the capacitive touch panel substrate prepared in the substrate preparation step, and
a thermal compression bonding step of bonding the external connection substrate, by thermal compression, to the thermal compression bonding region of the sensor section of the curved capacitive touch panel substrate prepared in the thermal molding step.
